(19) United States
(12) Patent Application Publication
(10) Pub. No.: US 2017/0337286 A1
(43) Pub. Date: Nov. 23, 2017

(54) SEARCH RESULT OPTIMIZING METHOD, SEARCH ENGINE, AN APPARATUS AND NON-VOLATILE COMPUTER STORAGE MEDIUM

(71) Applicant: BAIDU ONLINE NETWORK TECHNOLOGY (BEIJING) CO., LTD., Beijing (CN)

(72) Inventors: Xiaotian XU, Beijing (CN); Yan Jiang, Beijing (CN)

(73) Assignee: BAIDU ONLINE NETWORK TECHNOLOGY (BEIJING) CO., LTD., Beijing (CN)

(21) Appl. No.: 15/523,929

(22) PCT Filed: Nov. 11, 2015
(86) PCT No.: PCT/CN2015/094336

§ 371 Date: May 2, 2017

(30) Foreign Application Priority Data
Jun. 18, 2015 (CN) 201510340517.X

(51) Int. Cl. G06F 17/30

(52) U.S. Cl. CPC G06F 17/30867; G06F 17/30554; G06F 17/30277; G06F 17/30522

(57) ABSTRACT

The present disclosure provides a search result optimizing method, a search engine, an apparatus and a non-volatile computer storage medium. The optimizing method comprises: acquiring a user's search demand description information; acquiring an initial search result and search demand optimization information according to the search demand description information; according to the search demand optimization information selected by the user, performing optimization processing for the initial search result to obtain a final search result. The present disclosure may improve an accuracy of the search result.

The present disclosure claims priority to the Chinese patent application No. 201510340517.X entitled “Search Result Optimizing Method and Search Engine” filed on the filing date Jun. 18, 2015, the entire disclosure of which is hereby incorporated by reference in its entirety.

### FIELD OF THE DISCLOSURE

The present disclosure relates to the technical field of the Internet, and particularly to a search result optimizing method, a search engine, an apparatus and a non-volatile computer storage medium.

### BACKGROUND OF THE DISCLOSURE

Along with constant development of the Internet technologies and constant information expansion, people impose higher and higher requirements for use of network information, and a search engine becomes an important tool for people to acquire network information. The user inputs search demand description information such as a query or image, and the search engine returns a search result to the user according to the search demand description information.

In the prior art, the search demand description information input by the user might have many senses or the senses are broader, so the search engine might deviate upon understanding the user's search intention, which causes a lower accuracy of the returned search result.

### SUMMARY OF THE DISCLOSURE

A plurality of aspects of the present disclosure provide a search result optimizing method, a search engine, an apparatus and a non-volatile computer storage medium, to improve the accuracy of the search result.

According to an aspect of the present disclosure, there is provided a search result optimizing method, comprising:

acquiring a user's search demand description information;

acquiring an initial search result and search demand optimization information according to the search demand description information;

according to the search demand optimization information selected by the user, performing optimization processing for the initial search result to obtain a final search result.

According to another aspect of the present disclosure, there is provided a search engine, comprising:

a first acquiring module configured to acquire a user's search demand description information;

a second acquiring module configured to acquire an initial search result and search demand optimization information according to the search demand description information;

an optimization processing module configured to, according to the search demand optimization information selected by the user, perform optimization processing for the initial search result, to obtain a final search result.

According to a further aspect of the present disclosure, there is provided an apparatus, comprising

one or more processors;

a memory;

one or more programs stored in the memory and configured to execute the following operations when executed by the one or more processors:

acquiring a user's search demand description information;

acquiring an initial search result and search demand optimization information according to the search demand description information;

according to the search demand optimization information selected by the user, performing optimization processing for the initial search result to obtain a final search result.

According to a further aspect of the present disclosure, there is provided a non-volatile computer storage medium in which one or more programs are stored, an apparatus being enabled to execute the following operations when said one or more programs are executed by the apparatus:

acquiring a user's search demand description information;

acquiring an initial search result and search demand optimization information according to the search demand description information;

according to the search demand optimization information selected by the user, performing optimization processing for the initial search result to obtain a final search result.

As known from the above technical solutions, the present disclosure, after acquiring the user's search demand description information, does not directly offer a final search result according to the search demand description information as in the prior art, but acquires the initial search result and the search demand optimization information according to the search demand description information, and further performs optimization processing for the initial search result according to the user-selected search demand optimization information to obtain the final search result. The search result optimization processing with the user's participation can improve a matching degree of the search result and the user search demand, and improve the accuracy of the search result.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a search result optimizing method according to an embodiment of the present disclosure;

FIG. 2 is a schematic diagram of a type of search demand optimization information according to an embodiment of the present disclosure;

FIG. 3 is a schematic diagram of another type of search demand optimization information according to an embodiment of the present disclosure;

FIG. 4 is a schematic diagram of a further type of search demand optimization information according to an embodiment of the present disclosure;

FIG. 5 is a schematic diagram of a further type of search demand optimization information according to an embodiment of the present disclosure;

FIG. 6 is a block diagram of a search engine according to an embodiment of the present disclosure;

FIG. 7 is a block diagram of a search engine according to another embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

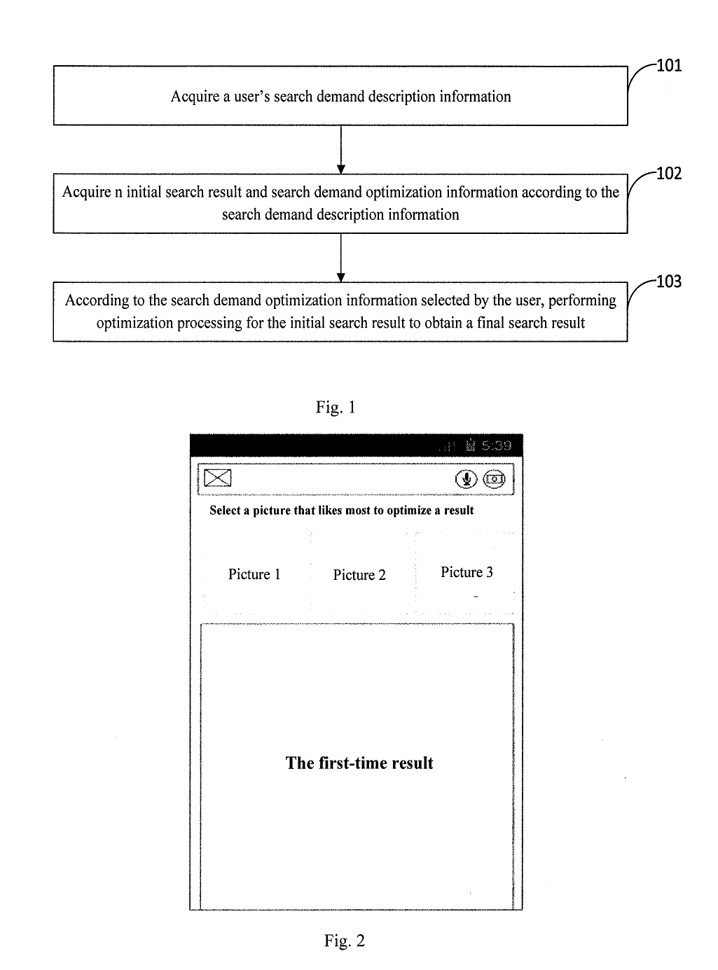

FIG. 1 is a flow chart of a search result optimizing method according to an embodiment of the present disclosure. As shown in FIG. 1, the method comprises:

101: acquiring a user's search demand description information.

102: acquiring an initial search result and search demand optimization information according to the search demand description information.

103: according to the search demand optimization information selected by the user, performing optimization processing for the initial search result to obtain a final search result.

The present embodiment provides a search result optimizing method which may be executed by a search engine to perform optimization process for the search result.

In practical search application, when the user needs to search, he generally input the search demand description information which is information describing the user's search demand. In the present embodiment, the search demand description information may be an image, a query or a combination of the image and query. The search engine acquires the user's search demand description information.

In some cases, the user's search demand description information has many senses or is understood in many ways, and cannot definitely express the user's search demand, so that the search engine cannot definitely determine the user's search demand according to the search demand description information

For example, suppose that the user's search demand description information is an image, the image is specifically a picture of part of a living room, and the picture includes a plurality of objects such as TV set, TV set cabinet, a background wall, a wireless router, a socket and the like. Such image simultaneously including a plurality of objects might express many kinds of user's search demands, for example, the user's search demand may be searching for TV set, or searching for a TV set cabinet, or searching for interior design, or searching for decoration or ornament, or searching for the wireless router and the like. The search engine cannot accurately determine the user's search demand, so the search engine cannot return a search result related to the TV. However, in fact the user might want to search for interior design through the above image. It can be seen that the search result returned by the search engine does not conform to the user's search demand, so the accuracy of the search result is relatively low.

For example, it is supposed that the user's search demand description information is a query such as “Apple”. The “Apple” may be understood as a mobile phone brand, or as fruit, or as a song name. The search engine cannot determine whether the user wants to search for a mobile phone, a fruit or a song name, and cannot accurately understand the user's search demand. Since currently Apple mobile phones are very hot, the search amount is larger, so what are provided by the search engine to the user according to the query “Apple” input by the user are search results related to mobile phones. However, in fact the user wants to learn about information of types of apples as fruits. It can be seen that the search result returned by the search engine does not conform to the user's search demand, so the accuracy of the search result is relatively low.

The search result optimizing method provided by the present embodiment may solve the above problem. A principle of the method according to the present embodiment is specifically as follows:

After acquiring the user's search demand description information, the search engine, instead of directly presenting a final search result according to the user's search demand description information in the prior art, presents an initial search result and search demand optimization information according to the user's search demand description information, and further performs optimization processing for the initial search result according to the search demand optimization information selected by the user to obtain a final search result. In the present embodiment, after obtaining the initial search result, the user may continue to participate in optimization processing for the initial search result based on the search demand optimization information, so this may improve a matching degree of the search result and the user search demand, and improve the accuracy of the search result.

In the present embodiment, the search demand optimization information is information whose search demand definiteness is higher than the search demand description information. Briefly, the search demand optimization information refers to information that more specifies the user's search demand (namely, the search demand definiteness is high) as compared with search demand description information. Meanwhile, the search demand optimization information is also information related to the search demand description information, for example, it may be information further defining the search demand description information in respect of attribute, or information having features similar to or identical with the search demand description information.

The present embodiment does not limit the form for implementing the search demand optimization information. All information forms capable of making the user search demand more definite than the search demand description information may serve as the search demand optimization information in the present embodiment, for example, it may be an image, a query or a combination of the image and query.

In an optional implementation mode, the manner of obtaining the initial search result and search demand optimization information according to the search demand description information comprises:

determining at least one search demand according to the search demand description information;

performing search according to an initial search demand in the at least one search demand to obtain the initial search result;

obtaining the search demand optimization information according to the initial search demand.

Specifically, the search engine identifies the search demand description information, for example, semantic identification or image identification, to determine at least one search demand that may be expressed by the search demand description information; determines the initial search demand from at least one search demand, the initial search demand being part or all of the search demand in the at least one search demand; performs search according to the initial search demand and obtaining the initial search result which is a search result matched with the initial search request; in addition, according to the initial search demand, determines the search demand optimization information to perform optimization processing for the initial search result.

It needs to be appreciated that since the initial search result needs to be optimized, the present embodiment, according to the initial search demand, determines the search demand optimization information making the user search demand more definite.

The manner of determining the search demand optimization information according to the initial search demand comprises:

considering at least one of description information of remaining search demand in said at least one search demand except the initial search demand and description information of a sub-search demand of the initial search demand, as the search demand optimization information.

For example, suppose that the user's search demand description information is a picture of part of a living room, the search demand description information cannot definitely express the user's search demand, and the search engine, based on the image, determines at least one search demand, including searching for TV set, or searching for a TV set cabinet, searching for interior design, searching for decoration or ornament, or searching for the wireless router and the like. Suppose that the search engine determines searching for the TV in at least one search demand as the initial search demand, and performs search based on the initial search demand to obtain a search result related to the TV as the initial search result; at the same time, the search engine determines description information of remaining search demand except for searching for the TV serving as the initial search demand, for example, the search demand such as searching for a TV set cabinet, searching for interior design, searching for decoration or ornament, or searching for the wireless router, as the search demand optimization information.

It needs to be appreciated that the search demand optimization information may be an image, a query or a combination of the image and query. For example, as for the search demand for searching for the TV set cabinet, its description information may be a sheet of image including the TV set cabinet; as for the search demand for searching for interior design, its description information may be a query “interior design”; as for the search demand for searching for the decoration or ornament, its description information may be a combination of one sheet of image including objects such as the TV set, TV set cabinet, background wall and wireless router with the query “decoration/ornament”; as for the search demand for searching for the wireless router, its description information may be a query “wireless router” or the like. It needs to be appreciated that in the case that the search demand description information is an image, the search demand optimization information is information specifically describing a certain object or feature in the image, to facilitate refining the user's search demand so that the user's search demand is more definite.

Furthermore, the search engine may further select the description information of the sub-search demand of the initial search demand as the search demand optimization information. The sub-search demand of the initial search demand refers to a more definite user search demand, and the search demand of the sub-search demand has a higher definiteness than the initial search demand. For example, the sub-search demand for searching for the TV set may be searching for a 64-inch TV set, or searching for a Haier TV set, or searching for a domestically-produced TV set or the like.

It needs to be appreciated that in the case that the search engine determines, from at least one search demand, partial search demand as the initial search demand, the description information of the remaining search demand is preferentially regarded as the search demand optimization information.

Optionally, after the search demand optimization information is obtained, the search demand optimization information may be displayed to the user to enable the user to select the search the search demand optimization information used in the optimization. Regarding a specific display form, the search engine may display the search demand optimization information to the user through an independent window, or may display a search result optimization information at an upper half of a search result page, and the like.

After viewing the search demand optimization information, the user may, in conjunction with the initial search result, determine whether to select the search demand optimization information to perform optimization processing for the initial search result. For example, the initial search result is “a search result related to the TV set”, but the user needs “interior design”. In this case, the user needs to select the search demand optimization information related to the “interior design” and perform optimization processing for the initial search result according to the selected search demand optimization information. The user may send a selection instruction and advise the search engine of the search demand optimization information selected by the user.

For example, the search engine may design the search demand optimization information as a control, and the user sends a selection instruction by clicking a relevant search demand optimization information. Alternatively, the search engine may set a selection control before the search demand optimization information for use by the user upon sending the control instruction. For example, the selection control may be a tick box, and the user sends a selection instruction by selecting the corresponding tick box.

After displaying the search demand optimization information to the user, the search engine may receive the user's selection instruction, and determine the user-selected search demand optimization information according to the selection instruction.

In a case with a plurality of search demand optimization information, the user may select one or more search demand optimization information therefrom.

After determining the user-selected search demand optimization information, the search engine may, according to the user-selected search demand optimization information, perform optimization processing for the initial search result to obtain a final search result.

Optionally, an optimization processing manner is: performing search again according to the user-selected search demand optimization information to obtain the final search result. This optimization manner performs search again to obtain more search results that are more accurate.

Another optimization processing manner is: performing screening for the initial search result according to the user-selected search demand optimization information to obtain the final search result. This optimization manner directly performs screening from already-existing results and exhibits a higher efficiency in acquiring an accurate search result.

In an optional implementation mode, the acquiring the user's search demand description information may be: acquiring a user-selected search demand optimization information in a previous optimization operation procedure as the search demand description information in the user's optimization operation of this time. This implementation mode means that the user may repeatedly execute optimization operations many times until an effect desired by the user is achieved or it is impossible to further offer the search demand optimization information or a preset repeated execution condition is reached, wherein the repeated execution condition may be preset maximum times of repeated execution, or preset maximum search time permitted by a single-time search.

It needs to be appreciated that the query belongs to information in text form and expresses a relatively definite sense; as compared with the query, an image includes a large number of objects and express a relatively vague sense. The method provided by the present embodiment is particular adapted for the case that the search demand description information includes an image.

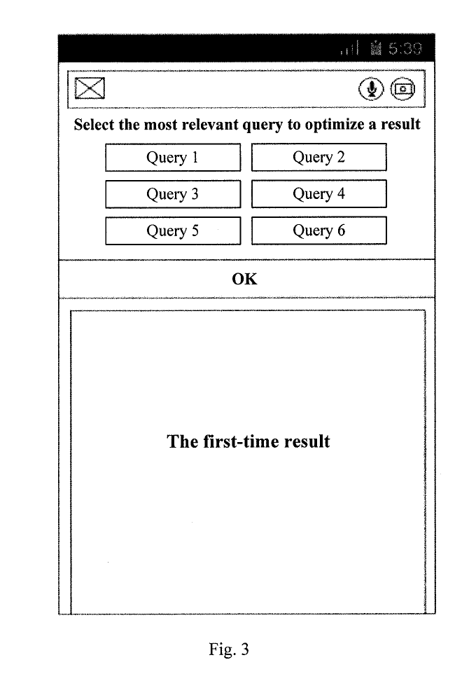

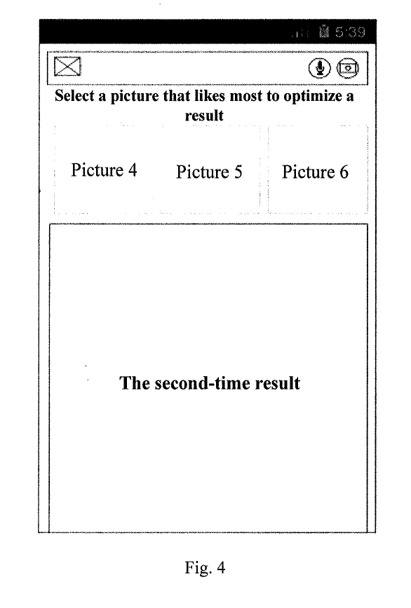

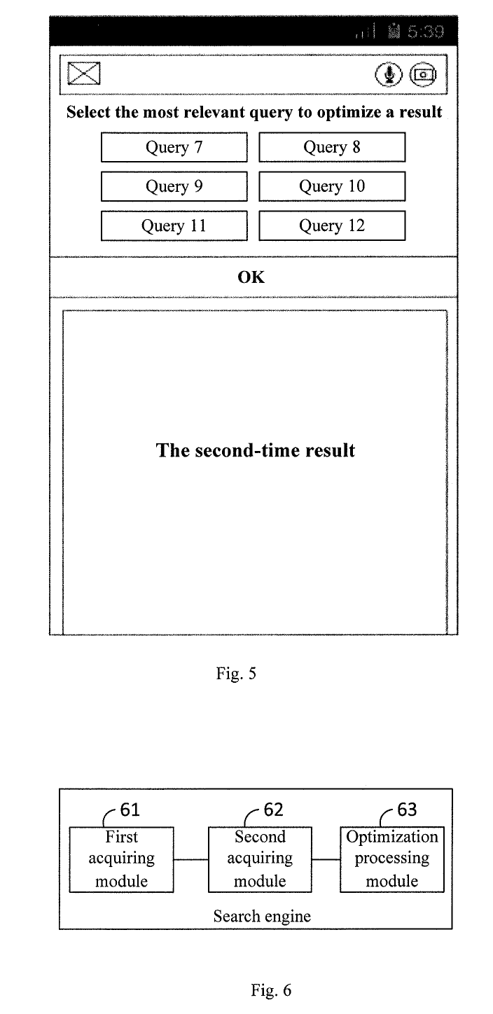

Image search is taken as an example. After the user activates the image search function, the user gets into an image acquiring procedure and shoots and uploads the image information, then the search engine performs search based on the image information and outputs the initial search result and the search demand optimization information. In addition to directly browsing the initial search result, the user may see the search demand optimization information. As shown in FIG. 2, the search demand optimization information is a picture, or as shown in FIG. 3, the search demand optimization information is a query, and as shown in FIG. 2 or FIG. 3, the picture or query as the search demand optimization information is located above the initial search result; if the user hopes to optimize the search result, he may click the corresponding search demand optimization information, and then the search result is optimized accordingly, and meanwhile new search demand optimization information is generated. As shown in FIG. 4, the new search demand optimization information is a picture, or as shown in FIG. 5, the search demand optimization information is a query, and as shown in FIG. 4 or FIG. 5, the picture or query as the search demand optimization information is located above the optimized search result; this goes again and again until the operation is completed after the search result is automatically judged as optimal.

As can be seen from the above, upon completion of uploading the image information, the user may further continue to participate, and continue to define the scope of the search result in the form of picture or query, and achieve the purpose of actively optimizing the search result. This may not only improve a matching degree between the final search result and the user search demand and improve the accuracy of the final search result, but also enhance the user's feeling of participating in products and improve the user's experience.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 6 is a block diagram of a search engine according to an embodiment of the present disclosure. As shown in FIG. 6, the search engine comprises: a first acquiring module 61, a second acquiring module 62 and an optimization processing module 63.

The first acquiring module 61 is configured to acquire a user's search demand description information.

The second acquiring module 62 is configured to acquire an initial search result and search demand optimization information according to the search demand description information acquired by the first acquiring module 61.

The optimization processing module 63 is configured to, according to the search demand optimization information selected by the user, perform optimization processing for the initial search result acquired by the second acquiring module 62, to obtain a final search result.

In an optional implementation mode, the second acquiring module 62 is specifically configured to:

determine at least one search demand according to the search demand description information;

perform search according to an initial search demand in the at least one search demand to obtain the initial search result;

determine the search demand optimization information according to the initial search demand.

Furthermore, upon determining the search demand optimization information according to the initial search demand, the second acquiring module 62 is specifically configured to:

consider at least one of description information of remaining search demand in said at least one search demand except the initial search demand and description information of a sub-search demand of the initial search demand, as the search demand optimization information.

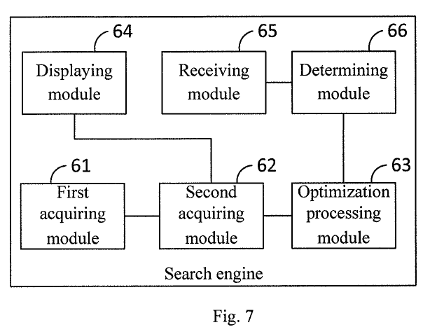

In an optional implementation mode, as shown in FIG. 7, the search engine further comprises: a displaying module 64, a receiving module 65 and a determining module 66.

The displaying module 64 is configured to display the search demand optimization information acquired by the second acquiring module 62 for the user's selection.

The receiving module 65 is configured to receive the user's selection instruction which indicates user-selected search demand optimization information.

The determining module 66 is configured to, according to the selection instruction received by the receiving module 65, determine the user-selected search demand optimization information.

In an optional implementation mode, the optimization processing module 63 is specifically configured to:

perform search again according to the user-selected search demand optimization information to obtain the final search result; or

perform screening for the initial search result according to the user-selected search demand optimization information to obtain the final search result.

In an optional implementation mode, the first acquiring module 61 may be specifically configured to: acquire the user-selected search demand optimization information in a previous optimization operation as the search demand description information in the user's optimization operation of this time.

In an optional implementation mode, the search demand description information is an image, but is not limited to this. The search demand description information may further be a query or a combination of the query and image.

In an optional implementation mode, the search demand description information is at least one of the image and the query.

The search engine provided by the present embodiment, after acquiring the user's search demand description information, does not directly offer a final search result according to the search demand description information as in the prior art, but acquires the initial search result and the search demand optimization information according to the search demand description information. The search engine further performs optimization processing for the initial search result according to the user-selected search demand optimization information to obtain the final search result. The search result optimization processing with the user's participation can improve a matching degree of the search result and the user search demand, and improve the accuracy of the search result.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. A search result optimizing method, wherein the method comprises:
acquiring a user's search demand description information;
acquiring an initial search result and search demand optimization information according to the search demand description information;
according to the search demand optimization information selected by the user, performing optimization processing for the initial search result to obtain a final search result.

2. The method according to claim 1, wherein the acquiring an initial search result and search demand optimization information according to the search demand description information comprises:
determining at least one search demand according to the search demand description information;
performing search according to an initial search demand in the at least one search demand to obtain the initial search result;
determining the search demand optimization information according to the initial search demand.

3. The method according to claim 2, wherein the determining the search demand optimization information according to the initial search demand comprises:
considering at least one of description information of remaining search demand in said at least one search demand except the initial search demand and description information of a sub-search demand of the initial search demand, as the search demand optimization information.

4. The method according to claim 1, wherein before the step of, according to the search demand optimization information selected by the user, performing optimization processing for the search result, the method comprises:
displaying the search demand optimization information for the user's selection;
receiving the user's selection instruction which indicates user-selected search demand optimization information;
according to the selection instruction, determining the user-selected search demand optimization information.

5. The method according to claim 1, wherein the step of, according to the user-selected search demand optimization information, performing optimization processing for the initial search result to obtain a final search result comprises:
performing search again according to the user-selected search demand optimization information to obtain the final search result; or
performing screening for the initial search result according to the user-selected search demand optimization information to obtain the final search result.

6. The method according to claim 1 wherein the acquiring a user's search demand description information comprises:
acquiring the user-selected search demand optimization information in a previous optimization operation as the search demand description information in the user's optimization operation of this time.

7. The method according to claim 1, wherein the search demand description information is an image:
the search demand optimization information is at least one of an image and a query.

8-16. (canceled)

17. An apparatus, comprising
one or more processors;
a memory;
one or more programs stored in the memory and configured to execute the following operations when executed by the one or more processors:
acquiring a user's search demand description information;
acquiring an initial search result and search demand optimization information according to the search demand description information;
according to the search demand optimization information selected by the user, performing optimization processing for the initial search result to obtain a final search result.

18. A non-volatile computer storage medium in which one or more programs are stored, an apparatus being enabled to execute the following operations when said one or more programs are executed by the apparatus:
acquiring a user's search demand description information;
acquiring an initial search result and search demand optimization information according to the search demand description information;
according to the search demand optimization information selected by the user, performing optimization processing for the initial search result to obtain a final search result.

19. The Apparatus according to claim 17, wherein the operation of acquiring an initial search result and search demand optimization information according to the search demand description information comprises:
determining at least one search demand according to the search demand description information;
performing search according to an initial search demand in the at least one search demand to obtain the initial search result;
determining the search demand optimization information according to the initial search demand.

20. The Apparatus according to claim 19, wherein the operation of determining the search demand optimization information according to the initial search demand comprises:
considering at least one of description information of remaining search demand in said at least one search demand except the initial search demand and description information of a sub-search demand of the initial search demand, as the search demand optimization information.

21. The Apparatus according to claim 17, wherein before the operation of, according to the search demand optimization information selected by the user, performing optimization processing for the search result, the operation further comprises:
displaying the search demand optimization information for the user's selection;
receiving the user's selection instruction which indicates user-selected search demand optimization information;
according to the selection instruction, determining the user-selected search demand optimization information.

22. The Apparatus according to claim 17, wherein the operation of, according to the user-selected search demand optimization information, performing optimization processing for the initial search result to obtain a final search result comprises:
performing search again according to the user-selected search demand optimization information to obtain the final search result; or
performing screening for the initial search result according to the user-selected search demand optimization information to obtain the final search result.

23. The Apparatus according to claim 17, wherein the operation of acquiring a user's search demand description information comprises:
acquiring the user-selected search demand optimization information in a previous optimization operation as the search demand description information in the user's optimization operation of this time.

24. The Apparatus according to claim 17, wherein the search demand description information is an image;
the search demand optimization information is at least one of an image and a query.

25. The non-volatile computer storage medium according to claim 18, wherein the operation of acquiring an initial search result and search demand optimization information according to the search demand description information comprises:
determining at least one search demand according to the search demand description information;
performing search according to an initial search demand in the at least one search demand to obtain the initial search result;
determining the search demand optimization information according to the initial search demand.

26. The non-volatile computer storage medium according to claim 25, wherein the operation of determining the search demand optimization information according to the initial search demand comprises:
considering at least one of description information of remaining search demand in said at least one search demand except the initial search demand and description information of a sub-search demand of the initial search demand, as the search demand optimization information.

27. The non-volatile computer storage medium according to claim 18, wherein before the operation of, according to the search demand optimization information selected by the user, performing optimization processing for the search result, the operation further comprises:
displaying the search demand optimization information for the user's selection;
receiving the user's selection instruction which indicates user-selected search demand optimization information;
according to the selection instruction, determining the user-selected search demand optimization information.

28. The non-volatile computer storage medium according to claim 18, wherein the operation of, according to the user-selected search demand optimization information, performing optimization processing for the initial search result to obtain a final search result comprises:
performing search again according to the user-selected search demand optimization information to obtain the final search result; or
performing screening for the initial search result according to the user-selected search demand optimization information to obtain the final search result.

29. The non-volatile computer storage medium according to claim 18, wherein the operation of acquiring a user's search demand description information comprises:
acquiring the user-selected search demand optimization information in a previous optimization operation as the search demand description information in the user's optimization operation of this time.

30. The non-volatile computer storage medium according to claim 18, wherein the search demand description information is an image;
the search demand optimization information is at least one of an image and a query.
